(19) United States
(12) Patent Application Publication
(10) Pub. No.: US 2018/0021208 A1
(43) Pub. Date: Jan. 25, 2018

(54) ORTHESIS FOR A VACUUM TREATMENT OF THE DEFORMATIONS OF THE THORAX

(71) Applicants: Christian CHOUX, Savigneux (FR); Bernard PAIN, Monistrol Sur Loire (FR); Centre Hospitalier Universitaire, Saint-Etienne (FR); Université Jean Monnet, Saint Etienne (FR)

(72) Inventors: Christian CHOUX, Savigneux (FR); Bernard PAIN, Monistrol Sur Loire (FR); Olivier TIFFET, Saint-Just-Saint-Rambert (FR)

(21) Appl. No.: 15/547,286

(22) PCT Filed: Feb. 4, 2016
(86) PCT No.: PCT/EP2016/052393

§ 371 Date: Jul. 28, 2017

(30) Foreign Application Priority Data
Feb. 10, 2015 (FR) 1551088

(51) Int. Cl. A61H 9/00; A61H 1/00

(52) U.S. Cl. CPC A61H 9/0057; A61H 1/008; A61H 2201/1619

(57) ABSTRACT

An orthosis for a vacuum treatment of the deformations of the thorax includes a bottom, a peripheral lip made of flexible, elastically deformable material and comes into sealing contact with the thorax so as to form a treatment space using negative pressure, and at least one suction head connected to a negative pressure generation component. The orthosis improves the sealing contact between the orthosis lip and the patient's thorax by increasing the orthosis deformability. To achieve this, the lip has a constant elasticity along the entire periphery thereof, and the bottom is formed of hollow, rigid, transverse side-by-side compartments connected to each other by bridges made of the same flexible material as the peripheral lip of the orthosis. The bridges of material allow the bottom to deform in such a way that the orthosis shape adapts to the thorax anatomy when the orthosis is applied vertically to the thorax.

### TECHNICAL FIELD

The disclosure relates to the non-surgical treatment of the funnel-shaped hollows of the thorax, called [symbol] pectus excavatum [symbol] , congenital or not.

It concerns more particularly a treatment orthosis, commonly called a [symbol] cup [symbol] , which is applied to the thorax by extending along a vertical direction extending from the head to the feet. By means of a depression acting on the sternum, cartilages and costal arches, the orthesis attracts the thoracic wall so that, at the end of treatment, the depth of the thoracic funnel is reduced.

### BACKGROUND

This non-invasive treatment is performed by means of various orthoses, the most common of which is the so-called orthosis of [symbol] Eckart KLOBE [symbol] , described in the document EP 1 469 804, and called [symbol] Suction cup for the non-invasive treatment of pectus excavatum [symbol] .

This prosthesis, in the shape of an open box facing the thorax, is composed of a bottom made of a transparent plastic material, capable of being brought parallel to the vertical plane of the thorax, and a peripheral skirt forming a sealing lip by coming into contact with the thorax. The skirt is defined between inner and outer faces, respectively, which flare from the bottom.

For an orthosis size to match all the meeting shapes of pectus excavatum, the KLOBE orthosis gives its peripheral lip a possibility of variable deformation, greater at the top and on the sides. This is obtained by giving the lip a trapezoidal cross section, whose thickness, defined between the inner and outer faces, respectively, varies depending on the desired deformability to ensure the sealing regardless of the configuration of the thorax. The variation in deformability is also obtained by modifying the inclination of the faces of the lip.

For the use, it turns out that the possibilities of elastic deformation of the lip vary during its manufacture and over time, so that it may be too hard, and injure the patient, or too flexible, and do not ensure a sufficient sealing so that the created vacuum exerts the antagonistic action of straightening of the muscles.

### SUMMARY

The aim of the disclosure is to remedy this by differently controlling the adjustment deformability of the prosthesis on the patient.

The prosthesis according to the disclosure has, in a known manner, a general shape of an open box and is composed of a bottom, parallel to the thorax, of a peripheral lip made of elastically deformable flexible material, extending around the bottom and capable of coming into sealed contact with the thorax, in order to form a vacuum treatment space, and at least one suction tip, said treatment space being connectable, by means of a flexible pipe with a vent valve, to a means generating a vacuum.

According to the disclosure, the bottom wall is formed by hollow and rigid juxtaposed compartments or cross-caissons linked to each other by bridges of the same flexible material as the bridges constituting the peripheral lip of the orthosis, these bridges of material giving the bottom wall a possibility of deformation allowing shaping the orthosis to the anatomy of the thorax when it is applied vertically against said thorax.

Thus, the sealing of the orthosis against the thorax does not depend on the variation in deformability of its peripheral lip but on the longitudinal deformability of the bottom carrying this lip.

The system of articulated caissons also allows the patient to be able to mobilize and in particular sit down.

In an embodiment of the disclosure, the bridges of flexible material between the cross-caissons have a thickness increasing from the thickness of the bridge of material applied against the top of the thorax.

This embodiment gives the orthosis a greater stiffness in its lower portion while its upper portion remains more deformable.

Advantageously, each of the bridges of flexible material between the cross-caissons has at least one longitudinal conduit or channel connecting the treatment spaces formed under the juxtaposed caissons.

With this disposition, all treatment spaces are balanced at the same pressure and provide a homogeneous treatment.

### BRIEF DESCRIPTION OF THE DRAWINGS

Other characteristics and advantages will emerge from the following description, with reference to the appended schematic drawing, showing several embodiments of this orthosis, wherein:

FIGS. 1 and 2 are respectively top and bottom perspective views of a four-compartment average orthosis;

FIGS. 3 and 4 are side sectional views on an enlarged scale, respectively along III-III and IV-IV of FIG. 1;

FIG. 5 is a plan top view of an average orthosis adapted to the female shaping;

FIGS. 6 and 7 are plan top views of orthoses for, respectively, large size and small size;

FIG. 8 is a perspective bottom view of the orthosis for small size;

FIG. 9 is a perspective bottom view of an embodiment of a four-compartment orthosis in which the communication between caissons is provided by channels;

FIG. 10 is a longitudinal sectional view of the orthosis of FIG. 9; and

FIG. 11 is a cross-sectional view along XI-XI of FIG. 9.

### DETAILED DESCRIPTION OF THE DRAWINGS

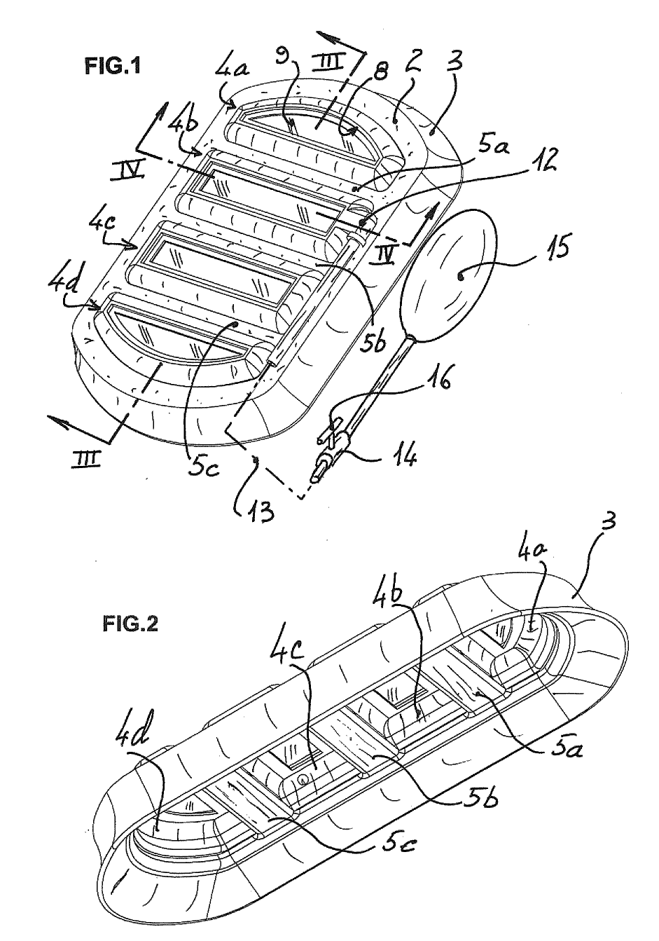

In the embodiment shown in FIGS. 1 to 4, the orthosis, in the shape of a box open downwardly, is composed of a bottom wall 2 and a peripheral lip 3, made of a flexible plastic material such as [symbol] silicones [symbol] or equivalent material.

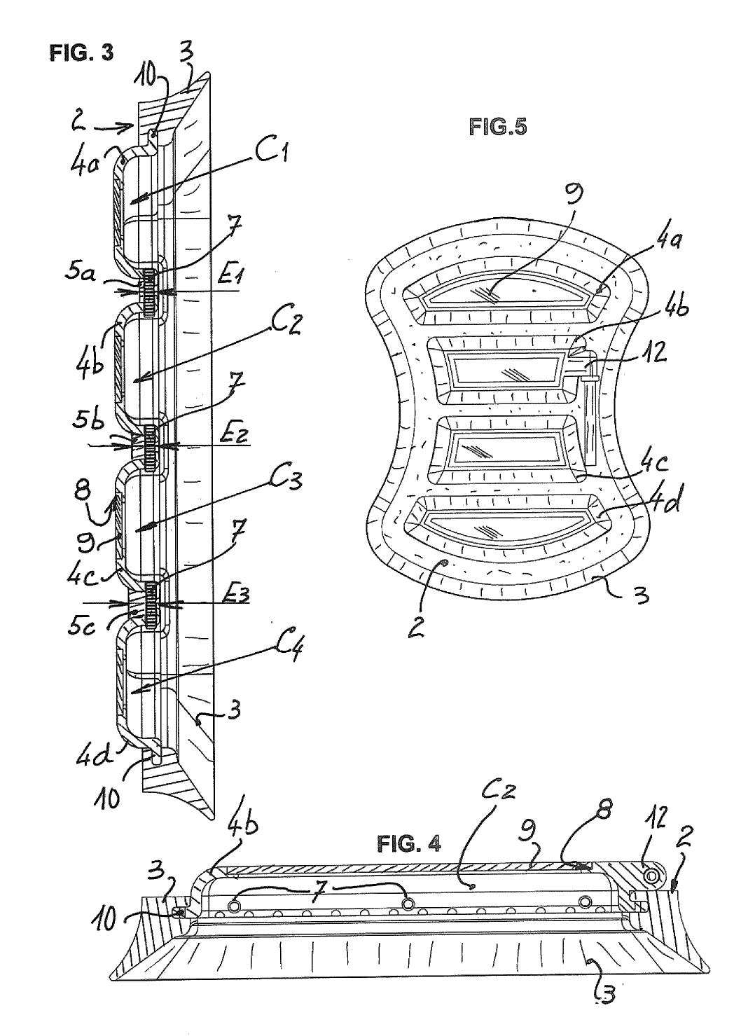

FIGS. 3 and 4 clearly show that the lip 3 has a constant substantially trapezoidal-shaped section, profile and dimensions over the entire periphery of the orthosis.

In this embodiment, the lip 3 is overmolded on the peripheral edges 10 of cross-caissons 4a to 4d, being hollow since having an inverted U-shaped cross section. These juxtaposed caissons 4 are made of rigid plastic material and are linked to each other by bridges of flexible material, referenced as 5a, 5b and 5c in FIGS. 1 to 3.

FIG. 3 shows that the thickness E1, E2 and E3 of the bridges of material 5a, 5b and 5c increases from the top to the bottom. This reduces the elasticity of these bridges to obtain an increasing variation of the stiffness allowing better shaping and application on the thorax upon the positioning.

In this embodiment, each bridge of material is crossed by at least one longitudinal conduit 7, in this case three in FIG. 4, communicating the treatment chambers C1 to C4 defined under the caissons 4.

Each caisson 4 comprises, at least locally, a window 8 obturated by a glazing 9 made of transparent plastic material, such as polycarbonate. This glazing allows visually adjusting the elevation of the sternum, induced by the vacuum.

Finally, and as shown in detail in FIGS. 1 and 4, one of the caissons, for example the central caisson 4d, includes laterally a bent tubular connection 12, capable of receiving one of the ends of a flexible pipe 13. The disposition of the air intake parallel to the thorax avoids the suction of the skin into the orifice, the clogging and the ulceration by contact with this suction orifice.

The other end of the pipe 13 is connectable to the tip 14 of a suction means, such as a bulb 15. In a known manner, this suction equipment is provided with a drain valve 16 allowing, at the end of treatment, venting the vacuum circuit.

In practice, the orthosis is placed on the funnel formed in the thorax of the patient, taking care to place the most flexible compartment C1 at the top, so that the orthosis has a stiffness increasing from the top to the bottom.

As soon as the patient bears on the bulb 15, the vacuum generated in the compartments C1 to C4, between the orthosis and the thorax, brings the bottom wall 2 closer to the thorax, thanks to the elasticity of the lip 3 and the sealing of its contact with the skin. The variations in deformity of the thorax are compensated by the deformation of the wall 2 of the prosthesis relative to the bridges of material 5a to 5c thereof.

The good sealing obtained allows, with an initial vacuum of the range of 0.1 to 0.3 atmosphere, maintaining the treatment during several hours without fatigue or pain for the patient.

The treatment is interrupted by opening the valve 16 and, after return of the compartments C1 to C4 at atmospheric pressure, by removing the orthesis.

The effectiveness of the treatment obtained by a continuous holding of the cup allows a reduction of the treatment by half.

It will be noted that, in order to form the extreme compartments, the extreme caissons 4a and 4d have circle segment shapes in order to give the orthosis rounded ends reducing its overall dimension and facilitating its installation on the thorax.

Likewise, in FIG. 5 showing an embodiment of a female orthosis, and therefore having to slide between the breasts, the caissons 4b and 4c have concave lateral edges matching to the general shape of the central portion of the orthosis, without modifying the general structure of the orthosis, its design and its elastic areas or with controlled stiffness.

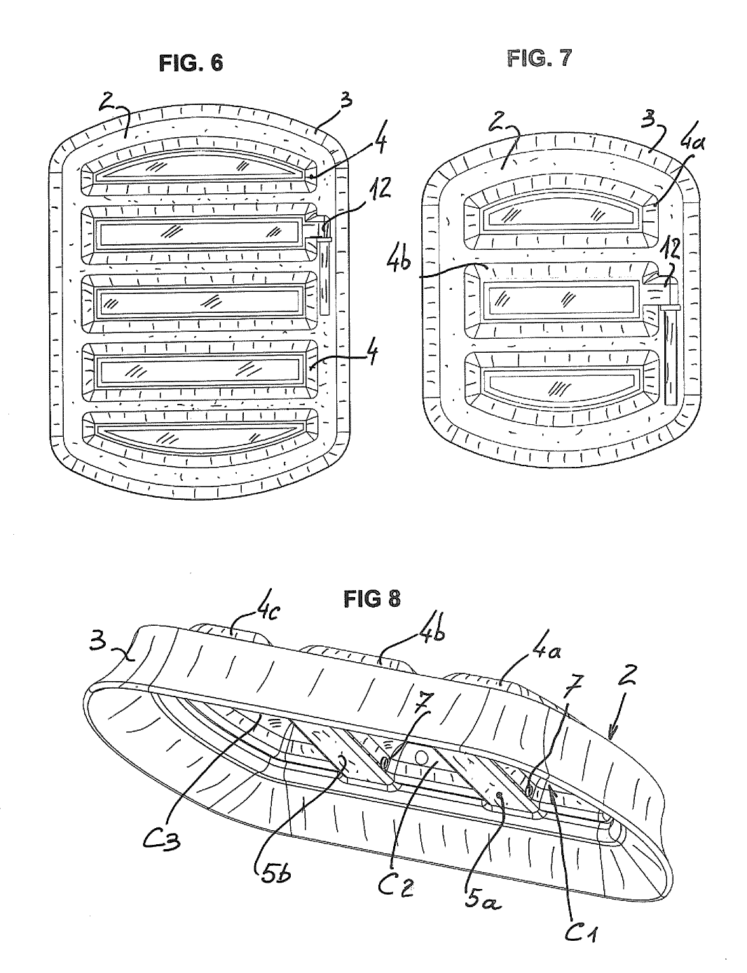

Until then, the description related to a four-caisson orthosis and three bridges of material, for a medium-sized patient, but it is evident that the dispositions according to the disclosure are also applied to orthoses with five caissons and four bridges of material, as shown in FIG. 6, for a large-sized patient, and to orthoses with three caissons and two bridges of material, such as shown in FIGS. 7 and 8 for a small-sized patient.

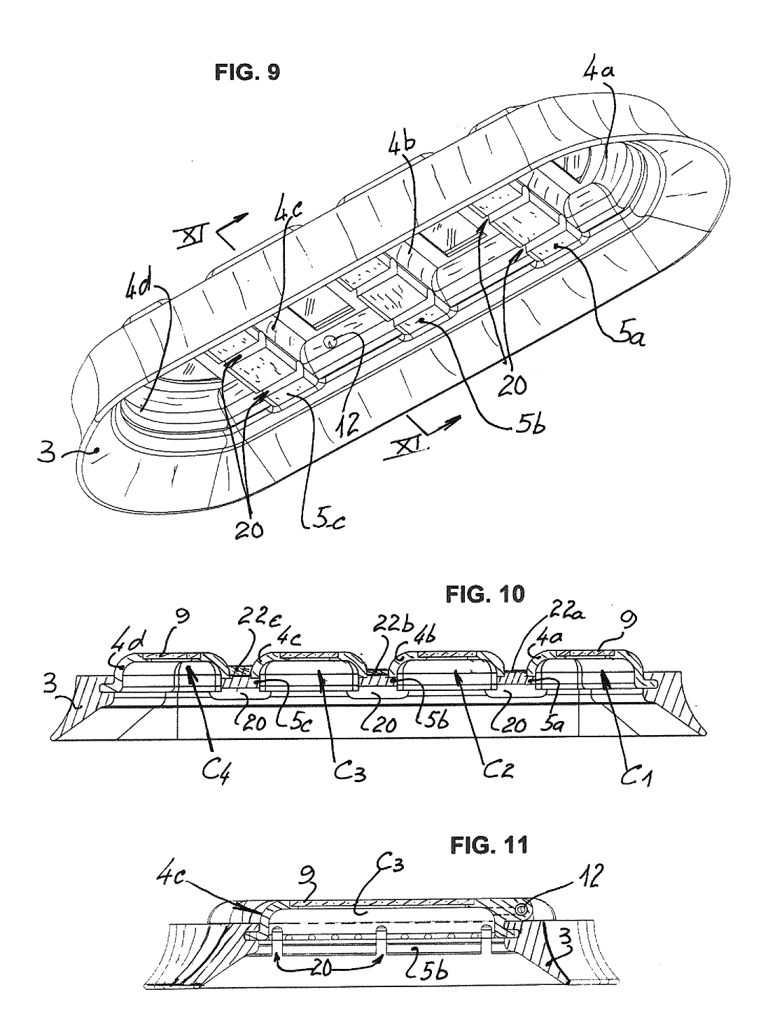

The embodiment of FIGS. 9 to 11 differs from previous embodiments by:
the replacement of the conduits 7, in the bridges of material 5a to 5n between the caissons 4a to 4n, by longitudinal channels 20 formed during the production of the orthesis by overmolding the caissons 4a to 4n;
the modification of the stiffness of the bridges of material by increasing the thickness of the material of the bridges and/or by adding, in each bridge, a plate 22a, 22b, 22c, each plate having a rigidity greater than the plate of the bridge of material which precedes it, either by variation of its thickness, or by its shape of section (flat, U-shaped or O-shaped section). In summary, relative to existing cup-shaped prostheses, the prosthesis according to the disclosure provides the following advantages:
the replacement of a rigid wall by a wall composed of rigid elements and of flexible elements, forming articulations, confers on the assembly a possibility of longitudinal deformation along the vertical axis, allowing its automatic shaping to the anatomy of the thorax, by eliminating the contact defects between lip and thorax factor of suction leaks;
a low overall dimension in height and a lightness allowing the diurnal and ambulant treatment;
The use of a reduced vacuum in the orthosis, reducing the discomfort of the patient and allowing carrying this orthesis longer each day, performing a softer, less painful and more comfortable treatment for the patient. In fact, better observance of the treatment by the children.
The bridges of material or siliconized cross-members constitute soft support bars for the suctioned thorax. This point is also an important comfort element, since it avoids bearing by an abrasive or aggressive material;
The lateral arrangement of the air intake avoiding the ulceration of the skin by contact with the suction orifice.

1. An orthosis for a vacuum treatment of the deformations of the thorax, said orthosis configured to be pressed against the thorax along a direction extending from the head to the feet, having the general shape of an open box applied against the thorax and having a bottom wall, a peripheral lip made of a flexible and elastically deformable material, extending around the bottom wall and capable of coming into sealed contact against the thorax, to form a vacuum treatment space, said space communicating, by at least one tip for connecting to a flexible pipe, to a means generating a vacuum, wherein the bottom is formed by hollow and rigid juxtaposed compartments, linked to each other by bridges made of the same flexible material as the peripheral lip, the bridges giving the bottom wall a possibility of deformation such that the orthosis is shaped to the anatomy of the thorax when the orthosis is applied vertically against the thorax.

2. The orthosis according to claim 1, wherein the bridges between the compartments have a thickness increasing from the thickness of the bridge of material applied against the top of the thorax.

3. The orthosis according to claim 1, wherein the bridges between the compartments have a stiffness increasing from that of the bridge of material applied against the top of the thorax, by adding, in each bridge, a plate, each plate having a greater rigidity than the plate of the bridge of material which precedes it, either by variation of its thickness, or by the shape of its section.

4. The orthosis according to claim 1, wherein each of the bridges contains at least one longitudinal conduit or channel connecting the treatment spaces formed under the compartments.

5. The orthosis according to claim 1, wherein the compartments have an inverted U-shaped cross-section.

6. The orthosis according to claim 1, wherein the core of each inverted U-shaped compartment comprises, at least locally, a window obturated by a glazing made of transparent plastic material.

7. The orthosis according to claim 1, wherein at least one of the compartments of the orthosis is extended by a lateral connection capable of receiving the end of the suction pipe coming from a suction means.
